(19) United States
(12) Patent Application Publication
(10) Pub. No.: US 2025/0155016 A1
(43) Pub. Date: May 15, 2025

(54) SHIFTING DEVICE

(71) Applicant: KABUSHIKI KAISHA TOKAI-RIKA-DENKI-SEISAKUSHO, Aichi (JP)

(72) Inventors: Kazuhiro SAITO, Niwa-gun, Aichi (JP); Minghui ZHAO, Niwa-gun, Aichi (JP); Ayumi KIMURA, Niwa-gun, Aichi (JP); Takuya SASAKI, Niwa-gun, Aichi (JP); Yoya OGAWA, Niwa-gun, Aichi (JP); Makoto YAMAMOTO, Niwa-gun, Aichi (JP)

(73) Assignee: KABUSHIKI KAISHA TOKAI-RIKA-DENKI-SEISAKUSHO, Aichi (JP)

(21) Appl. No.: 18/838,992

(22) PCT Filed: Feb. 8, 2023
(86) PCT No.: PCT/JP2023/004252

§ 371 Date: Aug. 15, 2024

(30) Foreign Application Priority Data
Feb. 18, 2022 (JP) 2022-024235

(51) Int. Cl. F16H 59/08; G05G 5/03

(52) U.S. Cl. CPC F16H 59/08; G05G 5/03; F16H 2059/081

(57) ABSTRACT

Provided is a shifting device in which, when the shift position of a knob is changed, an operation magnet in the knob is rotated by being attracted to a fixed magnet on the upper side of a plate, and thereafter, the operation magnet is rotated by being attracted to a fixed magnet on the knob-rotation direction side of said fixed magnet. In this case, the operation magnet and the fixed magnet oppose each other in the rotational-axis direction of the operation magnet. Consequently, the shifting device can be made smaller in the rotational-diameter direction of the operation magnet.

### TECHNICAL FIELD

The present invention relates to a shifting device in which a shift body is moved and a shift position is changed.

### BACKGROUND ART

In a knob shifter described in Chinese Patent Application Publication No. 110439992, a knob is rotated, and a magnetic device of the knob is rotated. Further, an attractive force is applied between the magnetic device and a magnet, and a rotational force is applied to the knob.

Here, in the knob shifter, the magnet is disposed in a rotational-diameter direction of the magnetic device.

### SUMMARY OF INVENTION

### Technical Problem

In consideration of the above fact, an object of the invention is to obtain a shifting device that can be downsized in a rotational-diameter direction of a first magnet.

### Solution to Problem

A shifting device according to a first aspect of the invention includes: a shift body that is moved to change a shift position; a first magnet that is rotated by moving the shift body; and a second magnet that is disposed on a rotational-axis direction side of the first magnet, an attractive force being applied between the first magnet and the second magnet to apply a moving force toward the shift position to the shift body.

According to a shifting device according to a second aspect of the invention, in the shifting device according to the first aspect of the invention, a detection device that detects a position of the first magnet and detects the shift position of the shift body is provided.

According to a shifting device according to a third aspect of the invention, in the shifting device according to the second aspect of the invention, a plurality of detection units are provided at the detection device, and the shift position of the shift body is changed to change the detection unit that detects the position of the first magnet.

According to a shifting device according to a fourth aspect of the invention, in the shifting device according to any one of the first to third aspects of the invention, a rotary body that is provided with the first magnet and is rotated in conjunction with the shift body is provided.

According to a shifting device according to a fifth aspect of the invention, in the shifting device according to any one of the first to fourth aspects of the invention, a third magnet that is disposed between one of the first magnets or the second magnets, a repulsive force being applied between another of the first magnets or the second magnets and the third magnet, is provided.

According to a shifting device according to a sixth aspect of the invention, in the shifting device according to any one of the first to fifth aspects of the invention, a fourth magnet, a repulsive force being applied between one of the first magnet or the second magnet and the fourth magnet; and a regulation portion that regulates rotation of the first magnet before a center of one of the first magnet or the second magnet and a center of the fourth magnet face each other are provided.

### Advantageous Effects of Invention

In the shifting device according to the first aspect of the invention, the shift body is moved, the shift position is changed, and the first magnet is rotated. Further, the attractive force is applied between the first magnet and the second magnet, and the moving force toward the shift position is applied to the shift body.

Here, the second magnet is disposed on the rotational-axis direction side of the first magnet. Therefore, the size can be reduced in a rotational-diameter direction of the first magnet.

In the shifting device according to the second aspect of the invention, the detection device detects the position of the first magnet, and the shift position of the shift body is detected. Therefore, the shift position of the shift body can be detected with a simple configuration.

In the shifting device according to the third aspect of the invention, the plurality of detection units are provided at the detection device, and the shift position of the shift body is changed to change the detection unit that detects the position of the first magnet. Therefore, a plurality of shift positions of the shift body can be detected.

In the shifting device according to the fourth aspect of the invention, the rotary body is provided with the first magnet, and the rotary body is rotated in conjunction with the shift body. Therefore, the configuration of the shift body can be simplified.

In the shifting device according to the fifth aspect of the invention, the third magnet is disposed between one of the first magnets or the second magnets, and the repulsive force is applied between the other of the first magnets or the second magnets and the third magnet. Therefore, the moving force toward the shift position can be applied to the shift body by the third magnet.

In the shifting device according to the sixth aspect of the invention, the repulsive force is applied between one of the first magnet or the second magnet and the fourth magnet.

Here, before the center of one of the first magnet or the second magnet and the center of the fourth magnet face each other, the regulation portion regulates the rotation of the first magnet. Therefore, it is possible to suppress a decrease in the rotational resistance force due to the repulsive force between one of the first magnet or the second magnet and the fourth magnet by the center of one of the first magnet or the second magnet facing the center of the fourth magnet, and it is possible to suppress a decrease in the movement resistance force applied to the shift body.

### BRIEF DESCRIPTION OF DRAWINGS

FIG. 1 is an exploded perspective view illustrating a shifting device according to a first embodiment of the invention.

FIG. 2A is a plan view illustrating an arrangement of a fixed magnet in the shifting device according to the first embodiment of the invention.

FIG. 2B is a plan view illustrating an arrangement of an operation magnet in the shifting device according to the first embodiment of the invention.

FIG. 3 is a graph illustrating a relation between a rotation stroke (horizontal axis) of a knob and a rotational resistance force (vertical axis) of the knob in the shifting device according to the first embodiment of the invention.

FIG. 4A is a plan view illustrating an arrangement of a fixed magnet in a shifting device according to a first modification of the first embodiment of the invention.

FIG. 4B is a plan view illustrating an arrangement of an operation magnet in the shifting device according to the first modification of the first embodiment of the invention.

FIG. 5 is a side view illustrating a fixed magnet and an operation magnet in a shifting device according to a second modification of the first embodiment of the invention.

FIG. 6A is a plan view illustrating an arrangement of a fixed magnet in a shifting device according to a third modification of the first embodiment of the invention.

FIG. 6B is a plan view illustrating an arrangement of an operation magnet in the shifting device according to the third modification of the first embodiment of the invention.

FIG. 6C is a plan view illustrating an arrangement of Hall ICs in the shifting device according to the third modification of the first embodiment of the invention.

FIG. 6D is a plan view illustrating an arrangement of Hall ICs in a shifting device according to a fourth modification of the first embodiment of the invention.

FIG. 7A is a bottom view illustrating ON/OFF states of Hall ICs when a knob is disposed at a first shift position in the shifting device according to the third modification of the first embodiment of the invention.

FIG. 7B is a bottom view illustrating ON/OFF states of Hall ICs when the knob is disposed at a second shift position in the shifting device according to the third modification of the first embodiment of the invention.

FIG. 7C is a bottom view illustrating ON/OFF states of Hall ICs when the knob is disposed at a third shift position in the shifting device according to the third modification of the first embodiment of the invention.

FIG. 7D is a bottom view illustrating ON/OFF states of Hall ICs when the knob is disposed at a fourth shift position in the shifting device according to the third modification of the first embodiment of the invention.

FIG. 8A is a bottom view illustrating ON/OFF states of Hall ICs when a knob is disposed at a first shift position in a shifting device according to the fourth modification of the first embodiment of the invention.

FIG. 8B is a bottom view illustrating ON/OFF states of Hall ICs when the knob is disposed at a second shift position in the shifting device according to the fourth modification of the first embodiment of the invention.

FIG. 8C is a bottom view illustrating ON/OFF states of Hall ICs when the knob is disposed at a third shift position in the shifting device according to the fourth modification of the first embodiment of the invention.

FIG. 8D is a bottom view illustrating ON/OFF states of Hall ICs when the knob is disposed at a fourth shift position in the shifting device according to the fourth modification of the first embodiment of the invention.

FIG. 9A is a table illustrating a relation between switching of the shift position of the knob and switching of ON/OFF of the Hall ICs in the shifting device according to the third modification of the first embodiment of the invention.

FIG. 9B is a table illustrating a relation between switching of the shift position of the knob and switching of ON/OFF of the Hall ICs in the shifting device according to the fourth modification of the first embodiment of the invention.

FIG. 10A is a plan view illustrating an arrangement of a fixed magnet in a shifting device according to a fifth modification of the first embodiment of the invention.

FIG. 10B is a plan view illustrating an arrangement of an operation magnet in the shifting device according to the fifth modification of the first embodiment of the invention.

FIG. 10C is a plan view illustrating an arrangement of Hall ICs in the shifting device according to the fifth modification of the first embodiment of the invention.

FIG. 10D is a plan view illustrating an arrangement of Hall ICs in a shifting device according to a sixth modification of the first embodiment of the invention.

FIG. 11A is a bottom view illustrating ON/OFF states of Hall ICs when a knob is disposed at a first shift position in the shifting device according to the fifth modification of the first embodiment of the invention.

FIG. 11B is a bottom view illustrating ON/OFF states of Hall ICs when the knob is disposed at a second shift position in the shifting device according to the fifth modification of the first embodiment of the invention.

FIG. 11C is a bottom view illustrating ON/OFF states of Hall ICs when the knob is disposed at a third shift position in the shifting device according to the fifth modification of the first embodiment of the invention.

FIG. 12A is a bottom view illustrating ON/OFF states of Hall ICs when a knob is disposed at a first shift position in the shifting device according to the sixth modification of the first embodiment of the invention.

FIG. 12B is a bottom view illustrating ON/OFF states of Hall ICs when the knob is disposed at a second shift position in the shifting device according to the sixth modification of the first embodiment of the invention.

FIG. 12C is a bottom view illustrating ON/OFF states of Hall ICs when the knob is disposed at a third shift position in the shifting device according to the sixth modification of the first embodiment of the invention.

FIG. 13A is a table illustrating a relation between the shift position of the knob and ON/OFF of the Hall ICs in the shifting device according to the fifth modification of the first embodiment of the invention.

FIG. 13B is a table illustrating a relation between switching of the shift position of the knob and switching of ON/OFF of the Hall ICs in the shifting device according to the fifth modification of the first embodiment of the invention.

FIG. 13C is a table illustrating a relation between switching of the shift position of the knob and switching of ON/OFF of the Hall ICs in the shifting device according to the sixth modification of the first embodiment of the invention.

FIG. 14 is an exploded perspective view illustrating a shifting device according to a second embodiment of the invention.

FIG. 15A is a plan view illustrating a knob, a first gear, and a second gear in a shifting device according to a seventh modification of the second embodiment of the invention.

FIG. 15B is a plan view illustrating an arrangement of first Hall ICs in the shifting device according to the seventh modification of the second embodiment of the invention.

FIG. 15C is a plan view illustrating an arrangement of second Hall ICs in the shifting device according to the seventh modification of the second embodiment of the invention.

FIG. 16A is a plan view illustrating ON/OFF states of first Hall ICs when the knob is disposed at a first shift position in the shifting device according to the seventh modification of the second embodiment of the invention.

FIG. 16B is a plan view illustrating ON/OFF states of second Hall ICs when the knob is disposed at the first shift position in the shifting device according to the seventh modification of the second embodiment of the invention.

FIG. 17A is a plan view illustrating ON/OFF states of first Hall ICs when the knob is disposed at a second shift position in the shifting device according to the seventh modification of the second embodiment of the invention.

FIG. 17B is a plan view illustrating ON/OFF states of second Hall ICs when the knob is disposed at the second shift position in the shifting device according to the seventh modification of the second embodiment of the invention.

FIG. 18A is a plan view illustrating ON/OFF states of first Hall ICs when the knob is disposed at a third shift position in the shifting device according to the seventh modification of the second embodiment of the invention.

FIG. 18B is a plan view illustrating ON/OFF states of second Hall ICs when the knob is disposed at the third shift position in the shifting device according to the seventh modification of the second embodiment of the invention.

FIG. 19A is a plan view illustrating ON/OFF states of first Hall ICs when the knob is disposed at a fourth shift position in the shifting device according to the seventh modification of the second embodiment of the invention.

FIG. 19B is a plan view illustrating ON/OFF states of second Hall ICs when the knob is disposed at the fourth shift position in the shifting device according to the seventh modification of the second embodiment of the invention.

FIG. 20 is a perspective view illustrating a fixed magnet, an operation magnet, and a return magnet in a shifting device according to a third embodiment of the invention.

FIG. 21A is a bottom view illustrating the fixed magnet, the operation magnet, and the return magnet when a knob is disposed at a third shift position in the shifting device according to the third embodiment of the invention.

FIG. 21B is a graph illustrating a relation between a rotation stroke (horizontal axis) of the knob and a rotation resistance force (vertical axis) of the knob when the knob is disposed at the third shift position in the shifting device according to the third embodiment of the invention.

FIG. 22A is a bottom view illustrating the fixed magnet, the operation magnet, and the return magnet when a knob is disposed at a second shift position in the shifting device according to the third embodiment of the invention.

FIG. 22B is a graph illustrating a relation between the rotation stroke (horizontal axis) of the knob and the rotation resistance force (vertical axis) of the knob when the knob is disposed at the second shift position in the shifting device according to the third embodiment of the invention.

FIG. 23A is a bottom view illustrating the fixed magnet, the operation magnet, and the return magnet when the knob is disposed at s first shift position in the shifting device according to the third embodiment of the invention.

FIG. 23B is a graph illustrating a relation between the rotation stroke (horizontal axis) of the knob and the rotation resistance force (vertical axis) of the knob when the knob is disposed at the first shift position in the shifting device according to the third embodiment of the invention.

### DESCRIPTION OF EMBODIMENTS

### First Embodiment

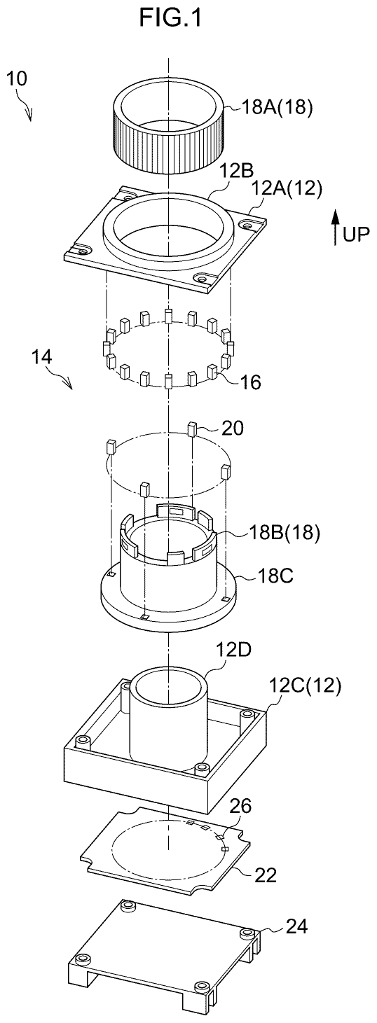

FIG. 1 is an exploded perspective view of a shifting device 10 according to a first embodiment of the invention. In the drawings, the upper side of the shifting device 10 is indicated by an arrow UP.

The shifting device 10 according to the present embodiment is installed in a vehicle, and the shifting device 10 is of a stationary type.

As illustrated in FIG. 1, the shifting device 10 is provided with a substantially rectangular parallelepiped box-shaped plate 12 as a fixed body, and the plate 12 is fixed to the vehicle body side. An upper plate 12A having a substantially rectangular plate shape is provided on the upper side of the plate 12, and a cylindrical penetration cylinder 12B is integrally formed with the upper plate 12A. The penetration cylinder 12B penetrates the upper plate 12A with its axial direction set to a vertical direction, and the inside of the penetration cylinder 12B is opened upward in the plate 12. A lower plate 12C having a substantially rectangular parallelepiped box shape is provided on the lower side of the plate 12, the inside of the lower plate 12C is opened upward, and the upper plate 12A is fixed to an upper end of the lower plate 12C. A substantially cylindrical support shaft 12D is integrally formed on a lower wall of the lower plate 12C, and the support shaft 12D protrudes upward and coaxially penetrates the penetration cylinder 12B.

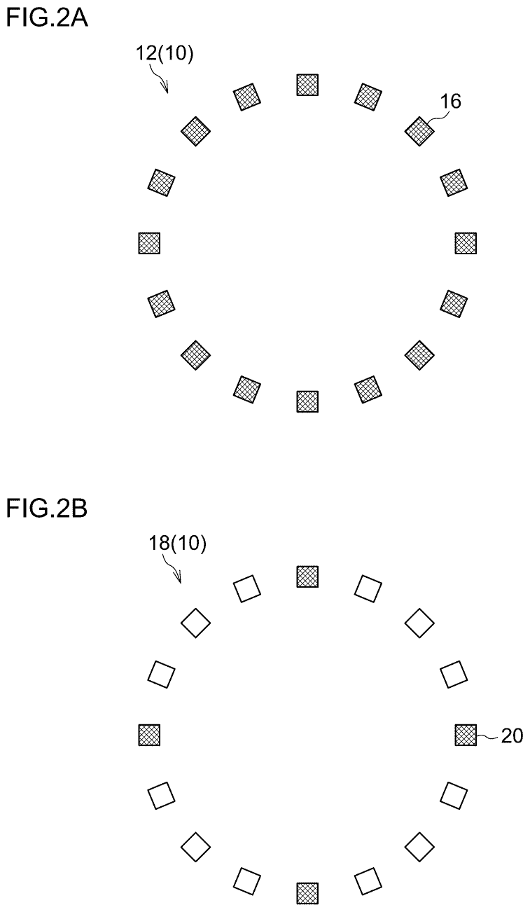

A plurality of (16 in the present embodiment) rectangular columnar fixed magnets 16 (see FIG. 2A) as second magnets included in a moderation mechanism 14 are fixed to the penetration cylinder 12B from below, and the plurality of fixed magnets 16 are arranged at equal intervals in a circumferential direction of the penetration cylinder 12B. The axial direction of the fixed magnet 16 is the vertical direction, and a lower end of the fixed magnet 16 has the same magnetic pole (one of an N pole or an S pole).

The plate 12 is provided with a substantially cylindrical knob 18 as a shift body (operation body). A substantially cylindrical operation cylinder 18A is provided on the upper side of the knob 18, and a substantially cylindrical rotary cylinder 18B is provided on the lower side of the knob 18. The operation cylinder 18A is coaxially fixed to the radially outer side of the upper portion of the rotary cylinder 18B. The support shaft 12D of the plate 12 is coaxially fitted in the rotary cylinder 18B, and the knob 18 is rotatable (movable) about the support shaft 12D. The rotary cylinder 18B coaxially penetrates the penetration cylinder 12B of the plate 12, and the operation cylinder 18A is disposed on the upper side of the plate 12 and is disposed in a vehicle interior. The knob 18 is rotatable in the operation cylinder 18A by a vehicle occupant (particularly, a driver), and the knob 18 is rotated to change a shift position of the knob 18 between a plurality of shift positions (in the present embodiment, for example, four shift positions of a “P” position (park position), an “R” position (reverse position), an “N” position (neutral position), and a “D” position (drive position)). A rotation angle of the knob 18 for changing the shift position of the knob 18 (hereinafter referred to as a “shift operation angle”) is equal to an arrangement interval angle of the fixed magnets 16 of the plate 12 (penetration cylinder 12B).

An annular enlarged diameter portion 18C is coaxially formed at a lower end portion of the rotary cylinder 18B, and the enlarged diameter portion 18C protrudes to the radially outer side of the knob 18. A plurality of (four in the present embodiment) rectangular columnar operation magnets 20 (see FIG. 2B) as first magnets included in the moderation mechanism 14 are fixed to the enlarged diameter portion 18C from above, and the plurality of operation magnets 20 are arranged at equal intervals in a circumferential direction of the enlarged diameter portion 18C. The axial direction of the operation magnet 20 is the vertical direction, and an upper end of the operation magnet 20 has the same magnetic pole (the other of the N pole or the S pole). When the knob 18 is rotated, the upper end of the operation magnet 20 sequentially faces the lower end of the fixed magnet 16 of the plate 12 (penetration cylinder 12B) above (in the rotational-axis direction of the knob 18). The upper end of the operation magnet 20 and the lower end of the fixed magnet 16 have opposite magnetic poles, and an attractive force by a magnetic force is applied between the upper end of the operation magnet 20 and the lower end of the fixed magnet 16. When the knob 18 is disposed at each shift position, the upper end of the operation magnet 20 faces the lower end of the fixed magnet 16 above.

A substantially rectangular plate-shaped detection substrate 22 as a detection device is provided below the plate 12 (lower plate 12C), and a substantially rectangular plate-shaped cover 24 is provided below the detection substrate 22. The cover 24 is fixed to the lower plate 12C, and the detection substrate 22 is positioned, sandwiched, and fixed between the cover 24 and the lower plate 12C. A plurality of (four in the present embodiment) switch-type Hall ICs 26 as detection units are fixed to a top surface of the detection substrate 22, and the plurality of Hall ICs 26 are arranged below the rotation locus of the operation magnet 20. When the knob 18 is disposed at each shift position, the lower end of the operation magnet 20 faces one Hall IC 26 different for each shift position below.

Next, functions of the present embodiment will be described.

In the shifting device 10 having the above configuration, the knob 18 is rotated to change the shift position of the knob 18.

When the knob 18 is disposed at each shift position, in the moderation mechanism 14, the upper end of the operation magnet 20 of the knob 18 and the lower end of the fixed magnet 16 of the plate 12 face each other in the vertical direction, and the attractive force in the vertical direction is applied between the upper end of the operation magnet 20 and the lower end of the fixed magnet 16, whereby the knob 18 is held at each shift position.

Furthermore, when the knob 18 is disposed at each shift position, one Hall IC 26 of the detection substrate 22 below the operation magnet 20 is turned on by the magnetic force of the lower end of the operation magnet 20 (the magnetic force of the lower end of the operation magnet 20 is detected), and the Hall ICs 26 other than the Hall IC 26 are turned off (the magnetic force of the lower end of the operation magnet 20 is not detected). As a result, every time the shift position of the knob 18 is changed, the Hall IC 26 to be turned on (the Hall IC 26 to be turned off) is changed, and the shift position of the knob 18 is detected.

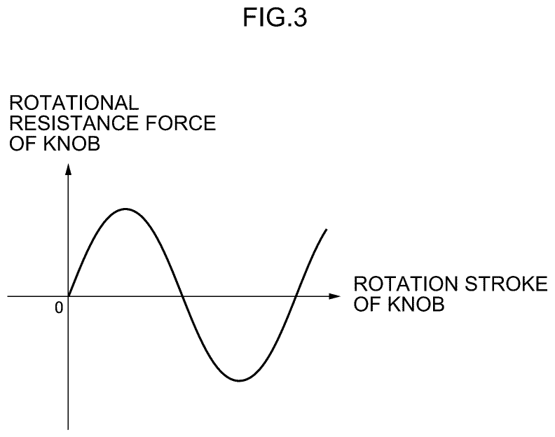

When the shift position of the knob 18 is changed (see FIG. 3), the upper end of the operation magnet 20 is rotated while being attracted to the lower end of the upper fixed magnet 16, and the rotational resistance force is applied to the knob 18. Thereafter, the upper end of the operation magnet 20 is rotated while being attracted to the lower end of the fixed magnet 16 on a rotation direction side of the knob 18 of said fixed magnet 16, and a rotational assist force is applied to the knob 18. In addition, a rotation circumferential component of the knob 18 of the attractive force between the upper end of the operation magnet 20 and the lower end of the fixed magnet 16 is maximized when the end of the upper end of the operation magnet 20 on the side opposite from the rotation direction of the knob 18 passes through the end of the lower end of the fixed magnet 16 on the side of the rotation direction of the knob 18 and when the end of the upper end of the operation magnet 20 on the side of the rotation direction of the knob 18 passes through the end of the lower end of the fixed magnet 16 on the side opposite from the rotation direction of the knob 18. Therefore, when the shift position of the knob 18 is changed, the rotational resistance force applied to the knob 18 is gradually increased and then gradually decreased, and the rotational assist force applied to the knob 18 is gradually increased and then gradually decreased. As a result, a magnetic force (biasing force) toward the shift position is applied to the knob 18, and a moderation feeling is applied to the operation of changing the shift position of the knob 18.

As described above, in the moderation mechanism 14, the magnetic force between the operation magnet 20 and the fixed magnet 16 causes a moderation feeling to be applied to the operation of changing the shift position of the knob 18. Therefore, since the operation magnet 20 and the fixed magnet 16 do not come into contact with each other, generation of a sound by the moderation mechanism 14 can be suppressed, wearing of the moderation mechanism 14 (the operation magnet 20 and the fixed magnet 16) can be suppressed, and it is possible to suppress that the moderation mechanism 14 (the operation magnet 20 and the fixed magnet 16) is damaged by the wearing and the knob 18 is not returned to the shift position by the magnetic force.

Here, the operation magnet 20 and the fixed magnet 16 face each other in the vertical direction (the rotational-axis direction of the knob 18 and the operation magnet 20). Therefore, the moderation mechanism 14 can be downsized in the rotational-diameter direction of the operation magnet 20, and the shifting device 10 can be downsized in the rotational-diameter direction of the knob 18.

In addition, the detection substrate 22 detects the position of the operation magnet 20, and the shift position of the knob 18 is detected. Therefore, the shift position of the knob 18 can be detected using the operation magnet 20 of the moderation mechanism 14, the shift position of the knob 18 can be detected with a simple configuration, the shifting device 10 can be downsized, the component cost of the shifting device 10 can be reduced, and the number of assembling steps of the shifting device 10 can be reduced.

Furthermore, the shift position of the knob 18 is changed, and the Hall IC 26 (the Hall IC 26 to be turned on) of the detection substrate 22 that detects the magnetic force of the lower end of the operation magnet 20 is changed. Therefore, a plurality of (four in the present embodiment) shift positions of the knob 18 can be detected.

In addition, the Hall IC 26 is of a switch type that can be switched between ON and OFF. Therefore, unlike the case where the Hall IC 26 detects the three-dimensional component of the magnetic force (so-called 3D Hall IC), the configuration of the Hall IC 26 can be simplified, and the cost can be reduced.

### (First Modification)

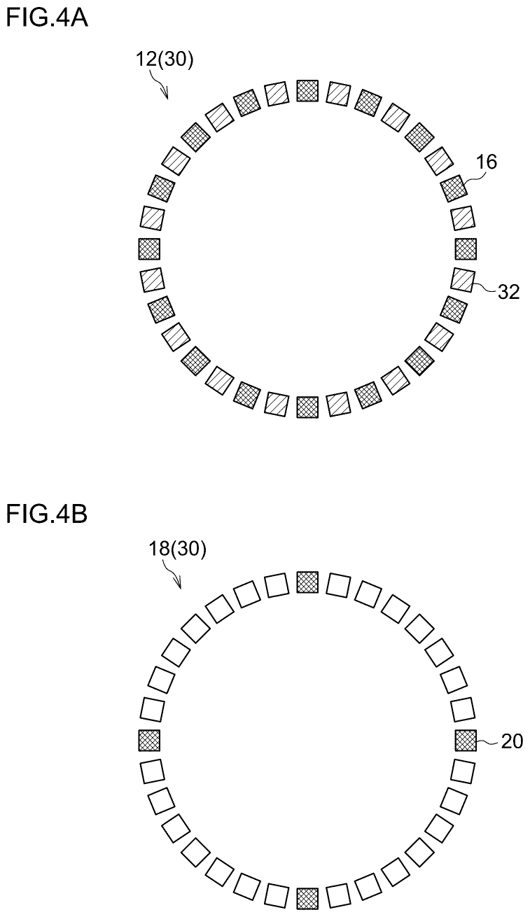

FIG. 4A is a plan view illustrating an arrangement of fixed magnets 16 in a shifting device 30 according to a first modification of the first embodiment of the invention, and FIG. 4B is a plan view illustrating an arrangement of operation magnets 20 in the shifting device 30.

As illustrated in FIG. 4A, in the shifting device 30 according to the first modification, a repulsive magnet 32 as a third magnet is fixed to the center between the fixed magnet 16 and the fixed magnet 16 in the penetration cylinder 12B of the plate 12, and a lower end of the repulsive magnet 32 has a magnetic pole opposite from that of a lower end of the fixed magnet 16. The lower end of the repulsive magnet 32 has the same magnetic pole as the upper end of the operation magnet 20, and a repulsive force due to a magnetic force is applied between the lower end of the repulsive magnet 32 and the upper end of the operation magnet 20.

As illustrated in FIG. 4B, the operation magnet 20 is fixed to the enlarged diameter portion 18C of the knob 18, similarly to the first embodiment.

Here, when the shift position of the knob 18 is changed, the upper end of the operation magnet 20 is rotated while being attracted to the lower end of the upper fixed magnet 16 and being repelled by the lower end of the repulsive magnet 32 on the rotation direction side of the knob 18 of said fixed magnet 16, and a rotational resistance force is applied to the knob 18. Thereafter, the upper end of the operation magnet 20 is rotated while being repelled by the lower end of said repulsive magnet 32 and being attracted to the lower end of the fixed magnet 16 on the rotation direction side of the knob 18 of said repulsive magnet 32, and the rotational assist force is applied to the knob 18. The rotation circumferential component of the knob 18 of the repulsive force between the upper end of the operation magnet 20 and the lower end of the repulsive magnet 32 is maximized when the end of the upper end of the operation magnet 20 on the side of the rotation direction of the knob 18 passes through the end of the lower end of the repulsive magnet 32 on the side opposite from the rotation direction of the knob 18 and when the end of the upper end of the operation magnet 20 on the side opposite from the rotation direction of the knob 18 passes through the end of the lower end of the repulsive magnet 32 on the side of the rotation direction of the knob 18.

Therefore, the rotational resistance force and the rotational assist force applied to the knob 18 can be increased, and the number of operation magnets 20 can be reduced (for example, 2).

### (Second Modification)

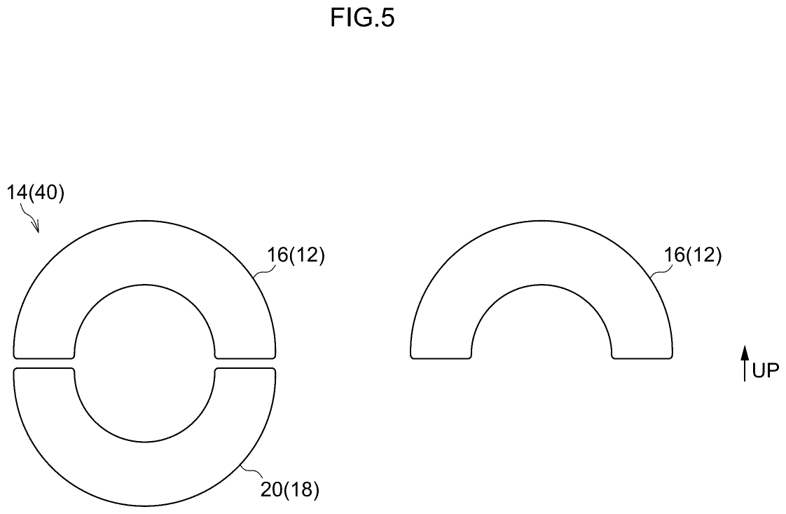

FIG. 5 is a side view of a fixed magnet 16 and an operation magnet 20 in a shifting device 40 according to a second modification of the first embodiment of the invention.

As illustrated in FIG. 5, in the shifting device 40 according to the second modification, the fixed magnet 16 is formed in a columnar shape or a plate shape having a U-shaped cross section, and one end (a lower end on one side in the rotation circumferential direction of the knob 18) of the fixed magnet 16 and the other end (a lower end on the other side in the rotation circumferential direction of the knob 18) of the fixed magnet 16 have opposite magnetic poles. Furthermore, the operation magnet 20 is formed in a columnar shape or a plate shape having a U-shaped cross section, and one end (the upper end on one side in the rotation circumferential direction of the knob 18) of the operation magnet 20 and the other end (the upper end on the other side in the rotation circumferential direction of the knob 18) of the operation magnet 20 have opposite magnetic poles. One end of the fixed magnet 16 and one end of the operation magnet 20 have opposite magnetic poles, and the other end of the fixed magnet 16 and the other end of the operation magnet 20 have opposite magnetic poles.

Here, when the knob 18 is disposed at each shift position, one end of the operation magnet 20 and one end of the fixed magnet 16 face each other in the vertical direction, the other end of the operation magnet 20 and the other end of the fixed magnet 16 face each other in the vertical direction, and the attractive force in the vertical direction is applied between one end of the operation magnet 20 and one end of the fixed magnet 16 and between the other end of the operation magnet 20 and the other end of the fixed magnet 16, whereby the knob 18 is held at each shift position.

When the shift position of the knob 18 is changed, one end (the end on the rotation direction side of the knob 18) and the other end (the end on the side opposite from the rotation direction of the knob 18) of the operation magnet 20 are respectively attracted to one end and the other end of said upper fixed magnet 16, the other end of the operation magnet 20 is repelled by one end of the upper fixed magnet 16, and one end of the operation magnet 20 is repelled by the other end of the next (the rotation direction side of the knob 18 of said upper fixed magnet 16) fixed magnet 16, whereby the rotational resistance force is applied to the knob 18. Thereafter, the other end of the operation magnet 20 is repelled by one end of said upper fixed magnet 16, and one end of the operation magnet 20 is repelled by the other end of said next fixed magnet 16, and one end and the other end of the operation magnet 20 are respectively attracted to one end and the other end of said next fixed magnet 16, whereby the rotational assist force is applied to the knob 18.

Therefore, the rotational resistance force and the rotational assist force applied to the knob 18 can be increased, and the operation magnet 20 and the fixed magnet 16 can be downsized.

It is possible to suppress a decrease in the rotational resistance force and the rotational assist force of the knob 18 due to the repulsive force (magnetic force) applied between the operation magnet 20 and the fixed magnet 16 (between the upper end of the operation magnet 20 and the upper end of the fixed magnet 16 and between the lower end of the operation magnet 20 and the lower end of the fixed magnet 16) like the first embodiment and the first modification. Furthermore, it is possible to suppress a decrease in the rotational resistance force and the rotational assist force of the knob 18 due to the attractive force (magnetic force) applied between the operation magnet 20 and the repulsive magnet 32 (between the upper end of the operation magnet 20 and the upper end of the repulsive magnet 32 and between the lower end of the operation magnet 20 and the lower end of the repulsive magnet 32) like the first modification. Therefore, the magnetic force of the operation magnet 20 and the fixed magnet 16 can be effectively used, and the rotational resistance force and the rotational assist force applied to the knob 18 can be increased.

In the second modification, one of the operation magnet 20 or the fixed magnet 16 may have a columnar shape similar to that of the first embodiment.

In the first embodiment (including the first modification and the second modification), the number of fixed magnets 16 and the number of repulsive magnets 32 are larger than the number of operation magnets 20. However, the number of operation magnets 20 may be larger than the number of fixed magnets 16 and the number of repulsive magnets 32. For example, the fixed magnet 16 and the repulsive magnet 32 may be arranged on the knob 18 as the first magnet and the third magnet, respectively, and the operation magnet 20 may be arranged on the plate 12 as the second magnet.

### (Third Modification)

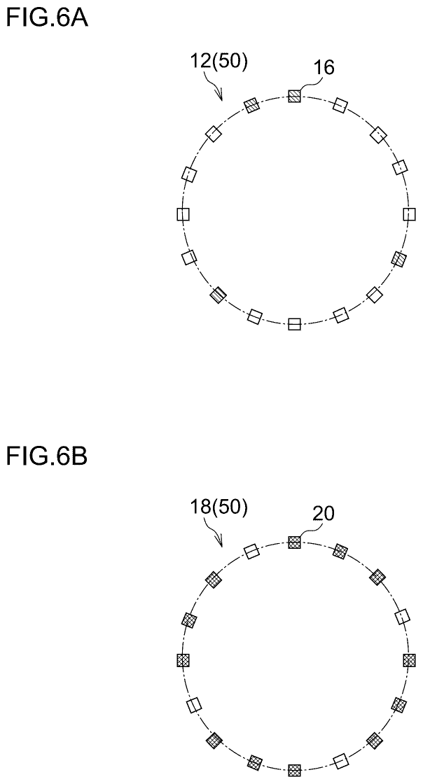

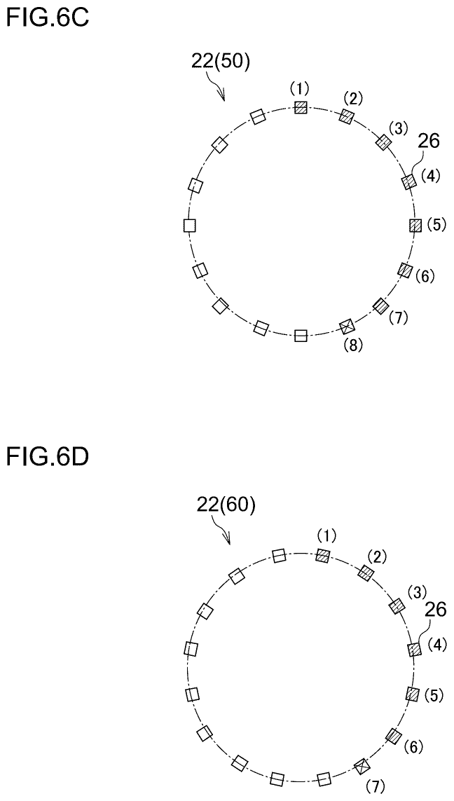

FIG. 6A is a plan view illustrating an arrangement of fixed magnets 16 in a shifting device 50 according to a third modification of the first embodiment of the invention, and FIG. 6B is a plan view illustrating an arrangement of operation magnets 20 in the shifting device 50. Furthermore, FIG. 6C is a plan view illustrating an arrangement of Hall ICs 26 in the shifting device 50.

As illustrated in FIGS. 6A to 6C, in the shifting device 50 according to the third modification, it is assumed that there are 16 arrangement positions for each shift operation angle in the rotation circumferential direction of the knob 18, and that there are four groups of four consecutive arrangement positions (the number of shift positions) (hereinafter referred to as “arrangement position groups”).

As illustrated in FIG. 6A, in the plate 12 (penetration cylinder 12B), the fixed magnets 16 are disposed at a first arrangement position in a first arrangement position group, a second arrangement position in a second arrangement position group on one side in the rotation circumferential direction of the knob 18 of the first arrangement position group, a third arrangement position in a third arrangement position group on one side in the rotation circumferential direction of the knob 18 of the second arrangement position group, and a fourth arrangement position in a fourth arrangement position group on one side in the rotation circumferential direction of the knob 18 of the third arrangement position group.

As illustrated in FIG. 6B, in the knob 18 (enlarged diameter portion 18C), the operation magnets 20 are arranged at the first to third arrangement positions in the first to the fourth arrangement position groups. Therefore, when the knob 18 is disposed at each shift position, three fixed magnets 16 and three operation magnets 20 face each other in the vertical direction.

As illustrated in FIG. 6C, in the detection substrate 22, the Hall ICs 26 are arranged at seven consecutive arrangement positions. Note that reference numerals (1) to (7) are attached to the seven Hall ICs 26 in the order toward one side in the rotation circumferential direction of the knob 18.

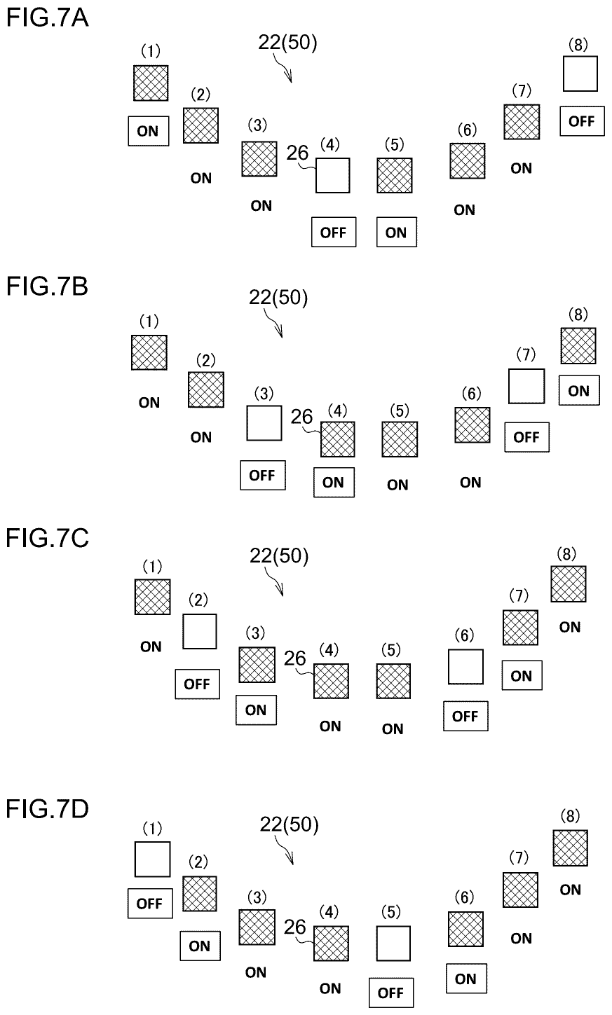

When the knob 18 is disposed at the first shift position to the fourth shift position, as illustrated in FIGS. 7A to 7D, the Hall ICs 26 of (1) to (7) are turned on (the magnetic force of the lower end of the operation magnet 20 on the upper side is detected) or turned off (the magnetic force of the lower end of the operation magnet 20 is not detected). Therefore, since a combination of ON and OFF of the Hall ICs 26 of (1) to (7) is different for each of the four shift positions of the knob 18, the four shift positions of the knob 18 can be detected.

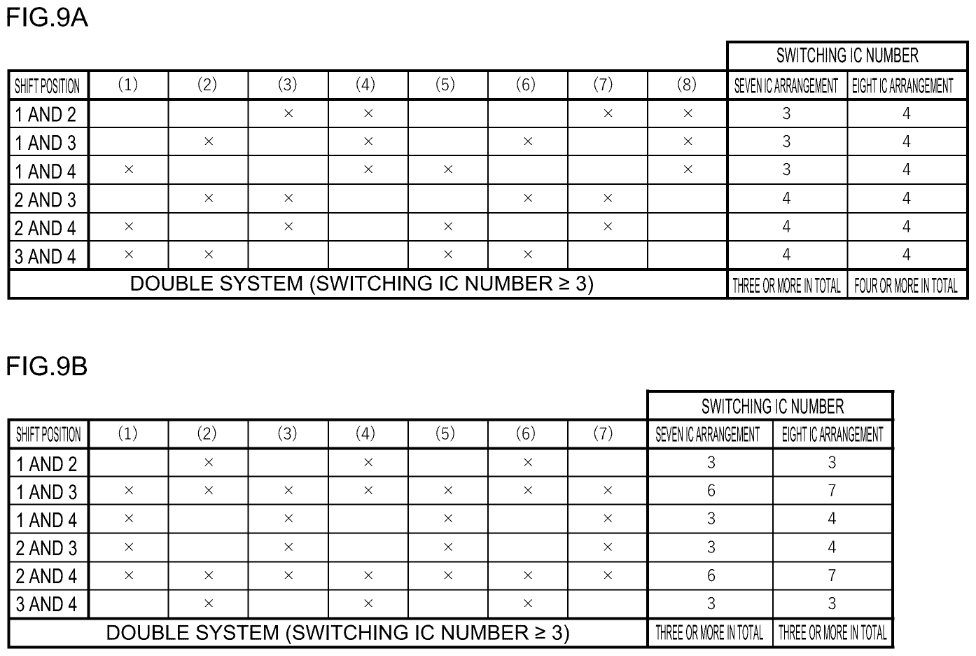

Further, as illustrated in FIG. 9A, when the shift position of the knob 18 is switched between the first shift position and the second shift position, when the shift position of the knob 18 is switched between the first shift position and the third shift position, when the shift position of the knob 18 is switched between the first shift position and the fourth shift position, when the shift position of the knob 18 is switched between the second shift position and the third shift position, when the shift position of the knob 18 is switched between the second shift position and the fourth shift position, and when the shift position of the knob 18 is switched between the third shift position and the fourth shift position, the number of Hall ICs 26 in which ON and OFF are switched is three or more. Therefore, the four shift positions of the knob 18 can be detected by a dual system, and detection accuracy of the four shift positions of the knob 18 can be improved.

In the third modification, as illustrated in FIG. 6C, the Hall ICs 26 may be disposed at eight consecutive arrangement positions. Even in this case, as illustrated in FIGS. 7A to 7D, a combination of ON and OFF of the Hall ICs 26 of (1) to (8) is different for each of the four shift positions of the knob 18, and as illustrated in FIG. 9A, the number of Hall ICs 26 in which ON and OFF are switched by switching each shift position of the knob 18 is three or more (four).

### (Fourth Modification)

FIG. 6D is a plan view illustrating an arrangement of Hall ICs 26 in a shifting device 60 according to a fourth modification of the first embodiment of the invention.

The shifting device 60 according to the fourth modification has substantially the same configuration as that of the third modification, but are different in the following points.

As illustrated in FIG. 6D, in the shifting device 60 according to the fourth modification, the Hall ICs 26 are arranged at the center between the six consecutive arrangement positions on the detection substrate 22. Note that reference numerals (1) to (6) are attached to the six Hall ICs 26 in the order toward one side in the rotation circumferential direction of the knob 18. The Hall IC 26 is turned on when the center between the lower ends of the operation magnets 20 adjacently provided at the shift operation angle is arranged on the upper side of the Hall IC 26, and is turned off when the center between the lower ends of the operation magnets 20 adjacently provided at the shift operation angle is not arranged on the upper side of the Hall IC 26.

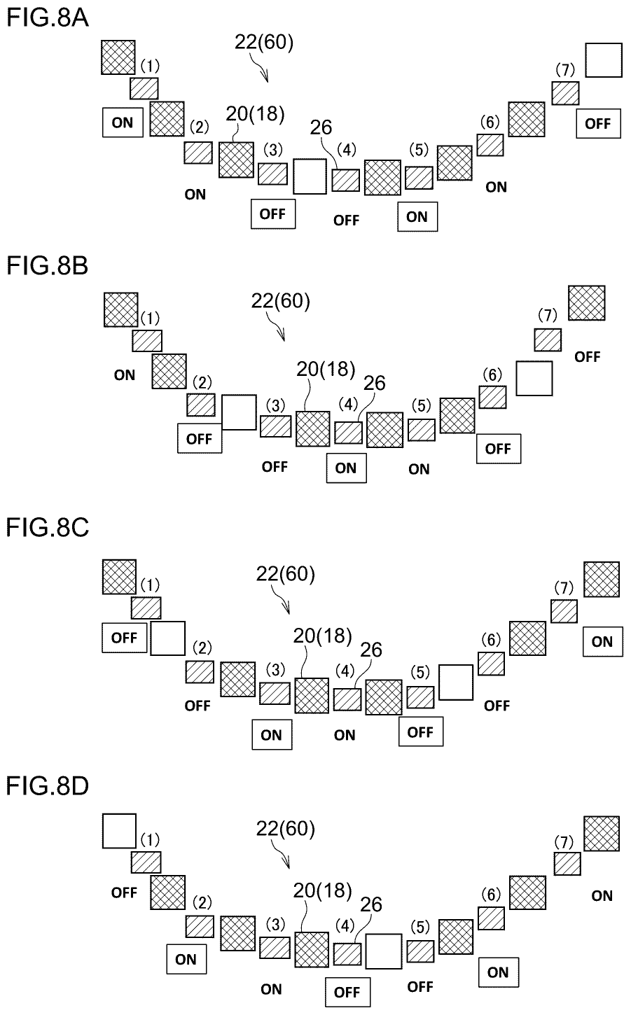

When the knob 18 is disposed at the first shift position to the fourth shift position, the Hall ICs 26 of (1) to (6) are turned on or off as illustrated in FIGS. 8A to 8D, respectively. Therefore, since a combination of ON and OFF of the Hall ICs 26 of (1) to (6) is different for each of the four shift positions of the knob 18, the four shift positions of the knob 18 can be detected.

Further, as illustrated in FIG. 9B, when the shift position of the knob 18 is switched between the first shift position and the second shift position, when the shift position of the knob 18 is switched between the first shift position and the third shift position, when the shift position of the knob 18 is switched between the first shift position and the fourth shift position, when the shift position of the knob 18 is switched between the second shift position and the third shift position, when the shift position of the knob 18 is switched between the second shift position and the fourth shift position, and when the shift position of the knob 18 is switched between the third shift position and the fourth shift position, the number of Hall ICs 26 in which ON and OFF are switched is three or more. Therefore, the four shift positions of the knob 18 can be detected by a dual system, and detection accuracy of the four shift positions of the knob 18 can be improved.

In the fourth modification, as illustrated in FIG. 6D, the Hall ICs 26 may be disposed at the center between seven consecutive arrangement positions. Even in this case, as illustrated in FIGS. 8A to 8D, a combination of ON and OFF of the Hall ICs 26 of (1) to (7) is different for each of the four shift positions of the knob 18, and as illustrated in FIG. 9B, the number of Hall ICs 26 in which ON and OFF are switched by switching each shift position of the knob 18 is three or more.

### (Fifth Modification)

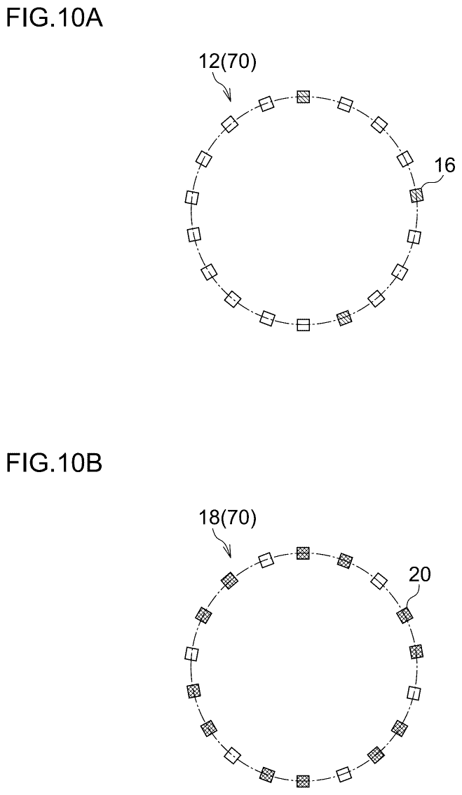

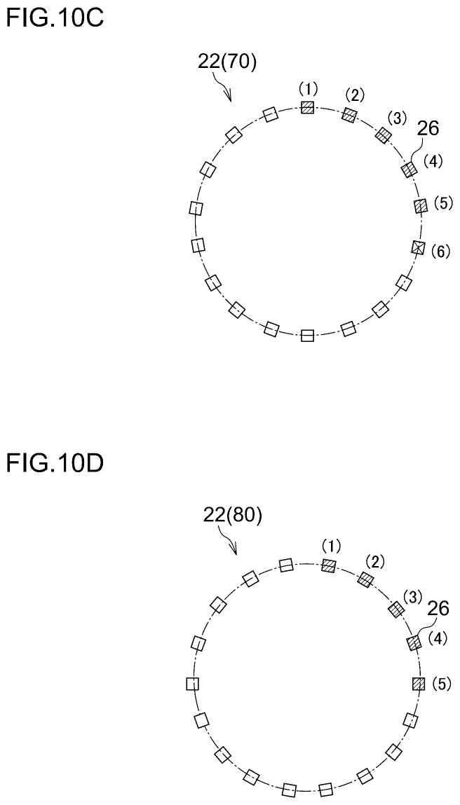

FIG. 10A is a plan view illustrating an arrangement of fixed magnets 16 in a shifting device 70 according to a fifth modification of the first embodiment of the invention, and FIG. 10B is a plan view illustrating an arrangement of operation magnets 20 in the shifting device 70. Furthermore, FIG. 10C is a plan view illustrating an arrangement of Hall ICs 26 in the shifting device 70.

In the shifting device 70 according to the fifth modification, the knob 18 is rotated, and the shift position of the knob 18 is changed, for example, among three shift positions of the “R” position, the “N” position, and the “D” position.

As illustrated in FIGS. 10A to 10C, it is assumed that there are 18 arrangement positions for each shift operation angle in the rotation circumferential direction of the knob 18, and that there are 6 groups (arrangement position groups) of three consecutive arrangement positions (the number of shift positions).

As illustrated in FIG. 10A, in the plate 12 (penetration cylinder 12B), the fixed magnets 16 are disposed at the first arrangement position in the first arrangement position group, the second arrangement position in the second arrangement position group on one side in the rotation circumferential direction of the knob 18 of the first arrangement position group, and the third arrangement position in the third arrangement position group on one side in the rotation circumferential direction of the knob 18 of the second arrangement position group.

As illustrated in FIG. 10B, in the knob 18 (enlarged diameter portion 18C), the operation magnets 20 are arranged at the first and second arrangement positions in the first arrangement position group to the sixth arrangement position group. Therefore, when the knob 18 is disposed at each shift position, two fixed magnets 16 and two operation magnets 20 face each other in the vertical direction.

As illustrated in FIG. 10C, in the detection substrate 22, the Hall ICs 26 are arranged at five consecutive arrangement positions. Note that reference numerals of (1) to (5) are attached to the five Hall ICs 26 in the order toward one side in the rotation circumferential direction of the knob 18.

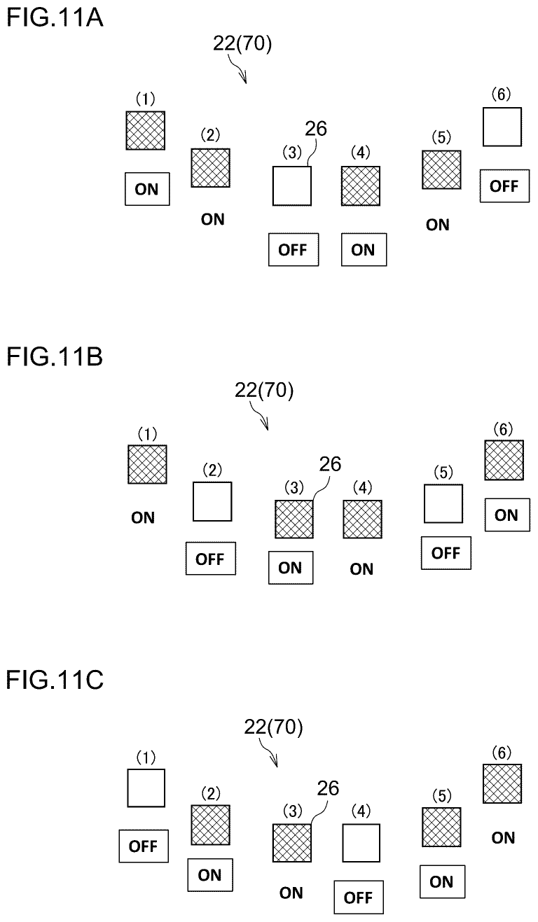

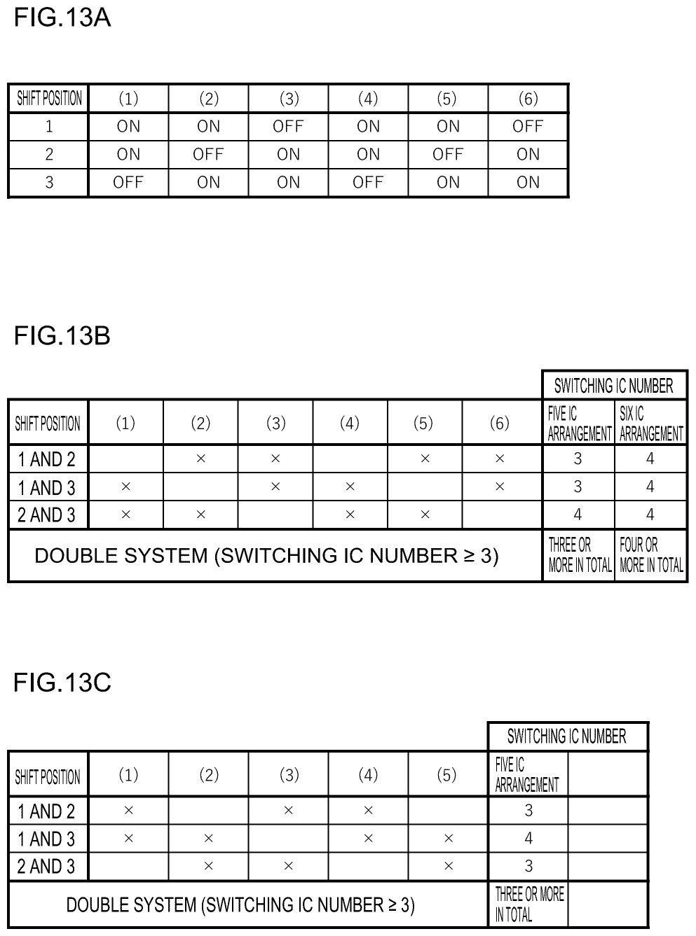

When the knob 18 is disposed at the first shift position to the third shift position, as illustrated in FIGS. 11A to 11C and 13A, the Hall ICs 26 of (1) to (5) are turned on (the magnetic force of the lower end of the operation magnet 20 on the upper side is detected) or turned off (the magnetic force of the lower end of the operation magnet 20 is not detected). Therefore, since a combination of ON and OFF of the Hall ICs 26 of (1) to (5) is different for each of the three shift positions of the knob 18, the three shift positions of the knob 18 can be detected.

Further, as illustrated in FIG. 13B, when the shift position of the knob 18 is switched between the first shift position and the second shift position, when the shift position of the knob 18 is switched between the first shift position and the third shift position, and when the shift position of the knob 18 is switched between the second shift position and the third shift position, the number of Hall ICs 26 in which ON and OFF are switched is three or more. Therefore, the three shift positions of the knob 18 can be detected by a dual system, and detection accuracy of the three shift positions of the knob 18 can be improved.

In the fifth modification, as illustrated in FIG. 10C, the Hall ICs 26 may be disposed at six consecutive arrangement positions. Even in this case, as illustrated in FIGS. 11A to 11C, a combination of ON and OFF of the Hall ICs 26 of (1) to (6) is different for each of the three shift positions of the knob 18, and as illustrated in FIG. 13B, the number of Hall ICs 26 in which ON and OFF are switched by switching each shift position of the knob 18 is three or more (four).

### (Sixth Modification)

FIG. 10D is a plan view illustrating an arrangement of Hall ICs 26 in the shifting device 80 according to the sixth modification of the first embodiment of the invention.

The shifting device 80 according to the sixth modification has substantially the same configuration as that of the fifth modification, but is different in the following points.

As illustrated in FIG. 10D, in the shifting device 80 according to the sixth modification, the Hall ICs 26 are arranged at the center between five consecutive arrangement positions on the detection substrate 22. Note that reference numerals of (1) to (5) are attached to the five Hall ICs 26 in the order toward one side in the rotation circumferential direction of the knob 18. The Hall IC 26 is turned on when the center between the lower ends of the operation magnets 20 adjacently provided at the shift operation angle is arranged on the upper side of the Hall ICs 26, and is turned off when the center between the lower ends of the operation magnets 20 adjacently provided at the shift operation angle is not arranged on the upper side of the Hall ICs 26.

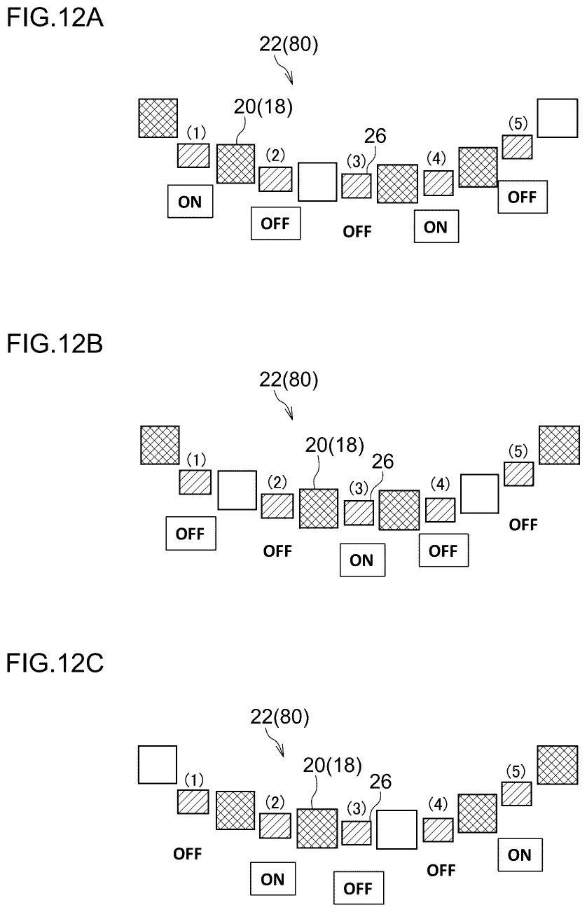

When the knob 18 is disposed at the first shift position to the third position, the Hall ICs 26 of (1) to (5) are turned on or off as illustrated in FIGS. 12A to 12C, respectively. Therefore, since a combination of ON and OFF of the Hall ICs 26 of (1) to (5) is different for each of the three shift positions of the knob 18, the three shift positions of the knob 18 can be detected.

Further, as illustrated in FIG. 13C, when the shift position of the knob 18 is switched between the first shift position and the second shift position, when the shift position of the knob 18 is switched between the first shift position and the third shift position, and when the shift position of the knob 18 is switched between the second shift position and the third shift position, the number of Hall ICs 26 in which ON and OFF are switched is three or more. Therefore, the three shift positions of the knob 18 can be detected by a dual system, and detection accuracy of the three shift positions of the knob 18 can be improved.

### Second Embodiment

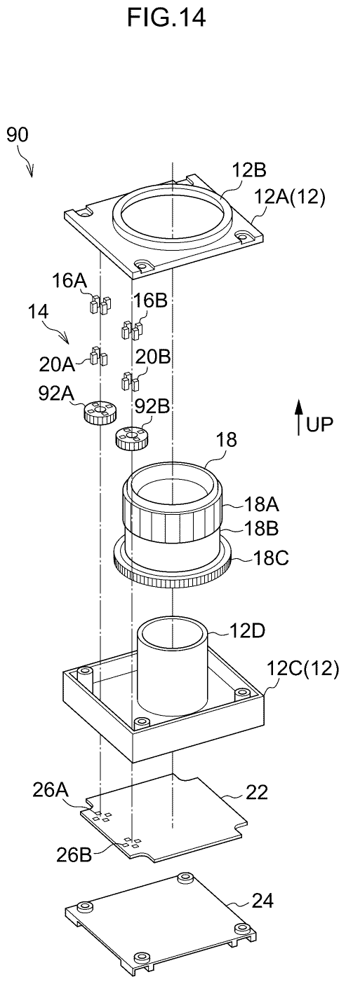

FIG. 14 is an exploded perspective view of a shifting device 90 according to a second embodiment of the invention.

The shifting device 90 according to the present embodiment has substantially the same configuration as that of the first embodiment, but is different in the following points.

As illustrated in FIG. 14, in the shifting device 90 according to the present embodiment, a rotating gear is formed in an enlarged diameter portion 18C of a knob 18 (rotary cylinder 18B).

In a plate 12 (lower plate 12C), a first gear 92A and a second gear 92B as rotary bodies included in a moderation mechanism 14 are supported, and the first gear 92A and the second gear 92B have the same configuration and are rotatable about a center axis parallel to a vertical direction. The first gear 92A and the second gear 92B engage with the enlarged diameter portion 18C (rotating gear) of the knob 18, and the knob 18 is rotated to rotate the first gear 92A and the second gear 92B. Every time a shift position of the knob 18 is changed, the first gear 92A and the second gear 92B are rotated by a shift rotation angle (90° in the present embodiment).

A plurality of (three in the present embodiment) operation magnets 20 (hereinafter referred to as “first operation magnets 20A”) are fixed to the first gear 92A from above, and the three first operation magnets 20A are arranged at intervals of a shift rotation angle in a rotation circumferential direction of the first gear 92A. A plurality of (three in the present embodiment) operation magnets 20 (hereinafter referred to as “second operation magnets 20B”) are fixed to the second gear 92B from above, and the three second operation magnets 20B are arranged at intervals of a shift rotation angle in the rotation circumferential direction of the second gear 92B.

In an upper plate 12A, a plurality of (four in the present embodiment) fixed magnets 16 (hereinafter referred to as “first fixed magnets 16A”) are fixed on the upper side of the first gear 92A, and the four first fixed magnets 16A are arranged above the rotation locus of the first operation magnet 20A and arranged at intervals of shift rotation angles in the rotation circumferential direction of the first gear 92A. In the upper plate 12A, a plurality of (four in the present embodiment) fixed magnets 16 (hereinafter referred to as “second fixed magnets 16B”) are fixed on the upper side of the second gear 92B, and the four second fixed magnets 16B are arranged above the rotation locus of the second operation magnet 20B and arranged at intervals of shift rotation angles in the rotation circumferential direction of the second gear 92B.

When the knob 18 is disposed at each shift position, the upper end of the first operation magnet 20A and the lower end of the first fixed magnet 16A face each other in the vertical direction (the rotational-axis direction of the first gear 92A), and the upper end of the second operation magnet 20B and the lower end of the second fixed magnet 16B face each other in the vertical direction (the rotational-axis direction of the second gear 92B).

A plurality of (four in the present embodiment) Hall ICs 26 (hereinafter referred to as “first Hall ICs 26A”) are fixed to a top surface of the detection substrate 22 below the first gear 92A, and the plurality of first Hall ICs 26A are arranged below the rotation locus of the first operation magnet 20A and are arranged at equal intervals in the rotation circumferential direction of the first gear 92A. On the top surface of the detection substrate 22, a plurality of (four in the present embodiment) Hall ICs 26 (hereinafter referred to as “second Hall ICs 26B”) are fixed below the second gear 92B, and the plurality of second Hall ICs 26B are arranged below the rotation locus of the second operation magnet 20B and are arranged at equal intervals in the rotation circumferential direction of the second gear 92B.

When the knob 18 is arranged at each shift position, the lower end of the first operation magnet 20A faces the first Hall IC 26A other than one first Hall IC 26A different for each shift position on the lower side, and the lower end of the second operation magnet 20B faces the second Hall IC 26B other than one second Hall IC 26B different for each shift position on the lower side.

Next, functions of the present embodiment will be described.

In the shifting device 90 having the above configuration, the knob 18 is rotated to change the shift position of the knob 18, and the first gear 92A and the second gear 92B are rotated.

When the knob 18 is disposed at each shift position, in the moderation mechanism 14, the upper end of the first operation magnet 20A of the first gear 92A and the upper end of the second operation magnet 20B of the second gear 92B face the lower end of the first fixed magnet 16A and the lower end of the second fixed magnet 16B of the plate 12 in the vertical direction respectively, and the attractive force in the vertical direction is applied between the upper end of the first operation magnet 20A and the lower end of the first fixed magnet 16A and between the upper end of the second operation magnet 20B and the lower end of the second fixed magnet 16B, whereby the rotational positions of the first gear 92A and the second gear 92B are held, and the knob 18 is held at each shift position.

Furthermore, when the knob 18 is disposed at each shift position, the first Hall IC 26A of the detection substrate 22 below the first operation magnet 20A is turned on by the magnetic force of the lower end of the first operation magnet 20A (the magnetic force of the lower end of the first operation magnet 20A is detected), and one first Hall IC 26A other than said first Hall IC 26A is turned off (the magnetic force of the lower end of the first operation magnet 20A is not detected). Moreover, when the knob 18 is disposed at each shift position, the second Hall IC 26B of the detection substrate 22 below the second operation magnet 20B is turned on by the magnetic force of the lower end of the second operation magnet 20B (the magnetic force of the lower end of the second operation magnet 20B is detected), and one second Hall IC 26B other than said second Hall IC 26B is turned off (the magnetic force of the lower end of the second operation magnet 20B is not detected). As a result, every time the shift position of the knob 18 is changed, the first Hall IC 26A to be turned on (the first Hall IC 26A to be turned off) and the second Hall IC 26B to be turned on (the second Hall IC 26B to be turned off) are changed, and the shift position of the knob 18 is detected.

When the shift position of the knob 18 is changed, the first gear 92A is rotated while the upper end of the first operation magnet 20A is attracted to the lower end of the upper first fixed magnet 16A, and the second gear 92B is rotated while the upper end of the second operation magnet 20B is attracted to the lower end of the upper second fixed magnet 16B, whereby a rotational resistance force is applied to the knob 18. Thereafter, the first gear 92A is rotated while the upper end of the first operation magnet 20A is attracted to the lower end of the first fixed magnet 16A on the rotation direction side of the first gear 92A of said first fixed magnet 16A, and the second gear 92B is rotated while the upper end of the second operation magnet 20B is attracted to the lower end of the second fixed magnet 16B on the rotation direction side of the second gear 92B of said second fixed magnet 16B, whereby a rotational assist force is applied to the knob 18. Therefore, a magnetic force (biasing force) toward the shift position is applied to the knob 18, and a moderation feeling is applied to the operation of changing the shift position of the knob 18.

Here, also in the present embodiment, functions and effects similar to those of the first embodiment can be obtained.

In particular, the first operation magnet 20A and the first fixed magnet 16A face each other in the vertical direction (the rotational-axis direction of the first gear 92A and the first operation magnet 20A), and the second operation magnet 20B and the second fixed magnet 16B face each other in the vertical direction (the rotational-axis direction of the second gear 92B and the second operation magnet 20B). Therefore, the moderation mechanism 14 can be downsized in the rotational-diameter direction of the first operation magnet 20A and the rotational-diameter direction of the second operation magnet 20B, and the shifting device 10 can be downsized in the rotational-diameter direction of the first operation magnet 20A and the rotational-diameter direction of the second operation magnet 20B.

Furthermore, the knob 18 is not provided with the first operation magnet 20A and the second operation magnet 20B. Therefore, the configuration of the knob 18 can be simplified, and the knob 18 can be downsized. Moreover, since the first operation magnet 20A and the second operation magnet 20B are provided in the first gear 92A and the second gear 92B, the degree of freedom of the installation positions of the first operation magnet 20A and the second operation magnet 20B can be increased.

In the present embodiment, a repulsive magnet 32 of the first modification may be applied, the repulsive magnet 32 may be provided between the first fixed magnets 16A, and the repulsive magnet 32 may be provided between the second fixed magnets 16B.

Furthermore, in the present embodiment, the second modification may be applied, at least one of the first operation magnet 20A and the first fixed magnet 16A may have a U-shaped cross section, and at least one of the second operation magnet 20B and the second fixed magnet 16B may have a U-shaped cross section.

In the second embodiment, the number of first fixed magnets 16A is larger than the number of first operation magnets 20A, and the number of second fixed magnets 16B is larger than the number of second operation magnets 20B. However, the number of first operation magnets 20A may be larger than the number of first fixed magnets 16A. For example, the first fixed magnet 16A may be disposed on the first gear 92A as the first magnet, and the first operation magnet 20A may be disposed on the plate 12 as the second magnet. Moreover, the number of second operation magnets 20B may be larger than the number of second fixed magnets 16B. For example, the second fixed magnet 16B may be disposed on the second gear 92B as the first magnet, and the second operation magnet 20B may be disposed on the plate 12 as the second magnet.

### (Seventh Modification)

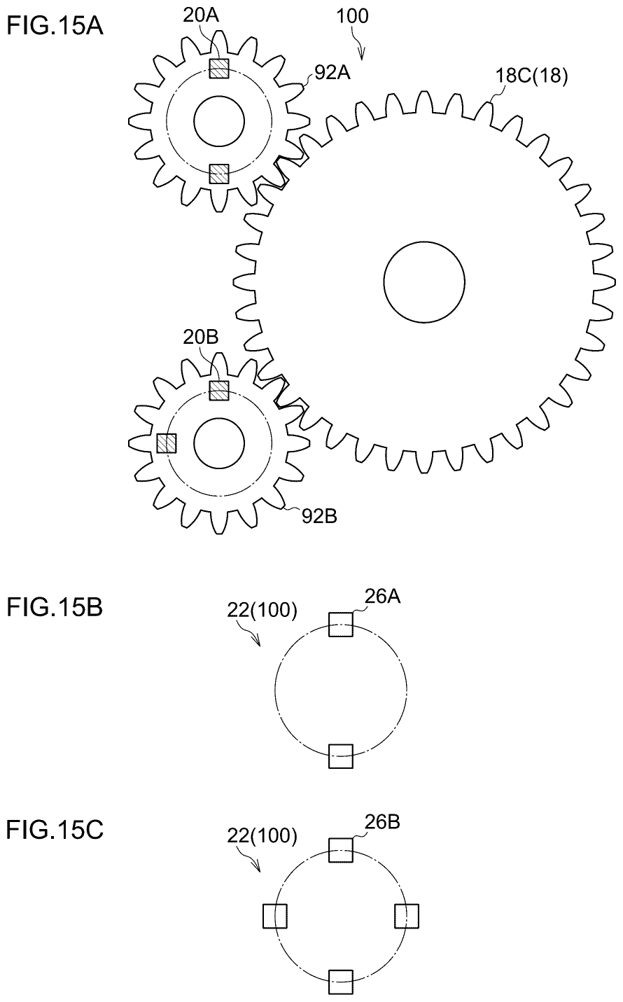

FIG. 15A is a plan view of a knob 18, a first gear 92A, and a second gear 92B in a shifting device 100 according to a seventh modification of the second embodiment of the invention. Furthermore, FIG. 15B is a plan view illustrating an arrangement of first Hall ICs 26A in the shifting device 100, and FIG. 15C is a plan view illustrating an arrangement of second Hall ICs 26B in the shifting device 100.

As illustrated in FIGS. 15A to 15C, in the shifting device 100 according to the seventh modification, it is assumed that there are four arrangement positions (the number of shift positions) for each shift rotation angle in the rotation circumferential direction of the first gear 92A and the second gear 92B.

As illustrated in FIG. 15A, in the first gear 92A, the first operation magnet 20A is arranged at the first and third arrangement positions, and in the second gear 92B, the second operation magnet 20B is arranged at the first and fourth arrangement positions. Therefore, when the knob 18 is disposed at each shift position, two first fixed magnets 16A and two first operation magnets 20A face each other in the vertical direction, and two second fixed magnets 16B and two second operation magnets 20B face each other in the vertical direction.

As illustrated in FIG. 15B, in the detection substrate 22, the first Hall ICs 26A are arranged at the first and third arrangement positions, and as illustrated in FIG. 15C, in the detection substrate 22, the second Hall ICs 26B are arranged at the first to fourth arrangement positions.

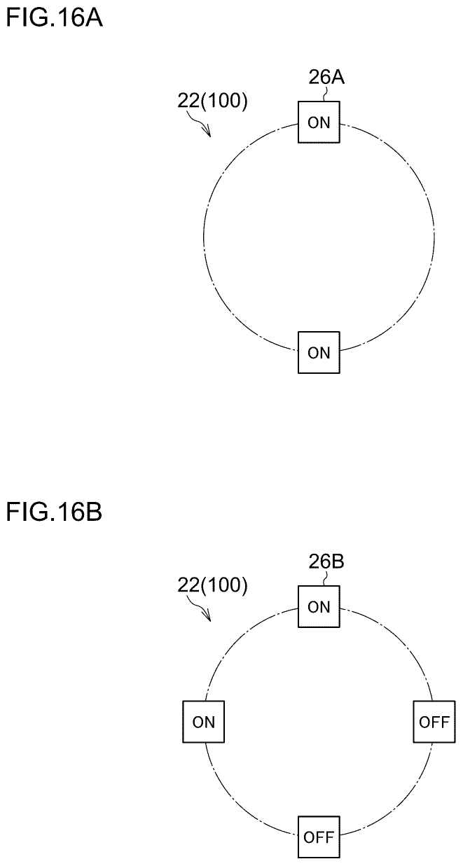

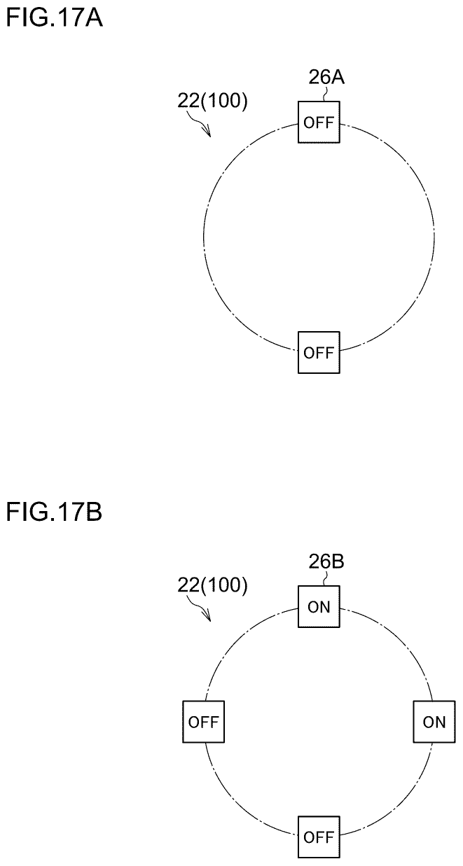

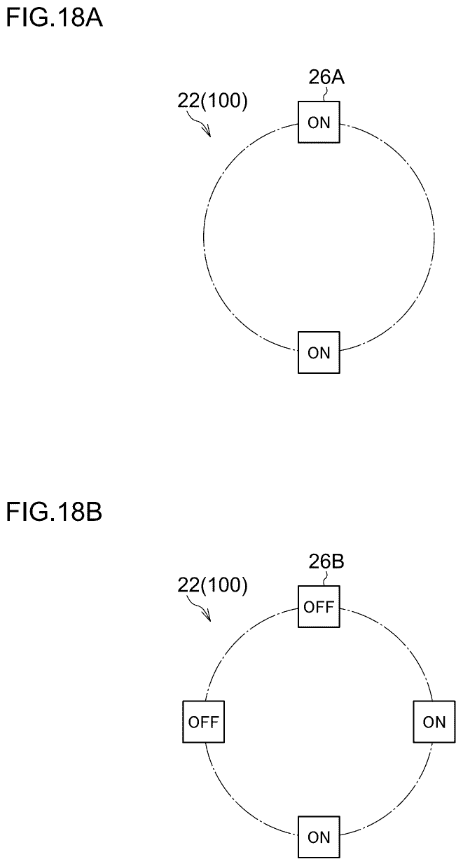

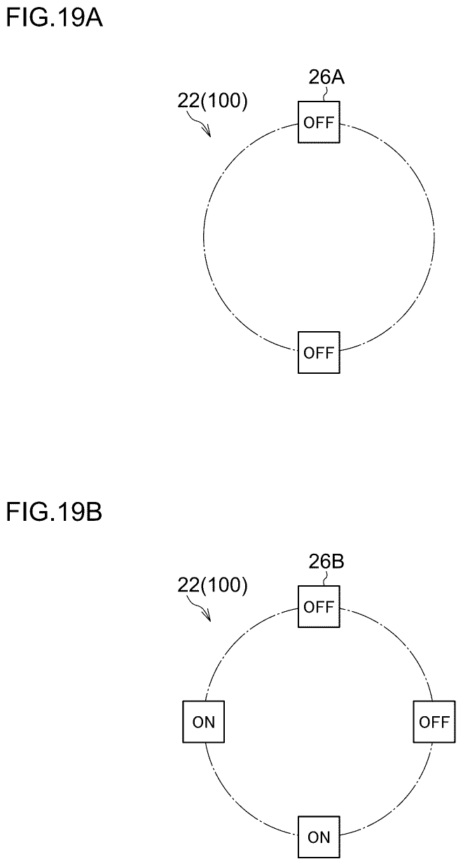

When the knob 18 is disposed at the first shift position to the fourth shift position, as illustrated in FIGS. 16A, 16B, 17A, 17B, 18A, 18B, 19A, and 19B, respectively, the first Hall IC 26A is turned on (the magnetic force of the lower end of the upper first operation magnet 20A is detected) or turned off (the magnetic force of the lower end of the first operation magnet 20A is not detected), and the second Hall IC 26B is turned on (the magnetic force of the lower end of the upper second operation magnet 20B is detected) or turned off (the magnetic force of the lower end of the second operation magnet 20B is not detected). Therefore, since a combination of ON and OFF of the first Hall IC 26A and the second Hall IC 26B is different for each of the four shift positions of the knob 18, the four shift positions of the knob 18 can be detected.

Further, when the shift position of the knob 18 is switched between the first shift position and the second shift position, when the shift position of the knob 18 is switched between the first shift position and the third shift position, when the shift position of the knob 18 is switched between the first shift position and the fourth shift position, when the shift position of the knob 18 is switched between the second shift position and the third shift position, when the shift position of the knob 18 is switched between the second shift position and the fourth shift position, and when the shift position of the knob 18 is switched between the third shift position and the fourth shift position, the number of first Hall ICs 26A and second Hall ICs 26B in which ON and OFF are switched is three or more (four). Therefore, the four shift positions of the knob 18 can be detected by a dual system, and detection accuracy of the four shift positions of the knob 18 can be improved.

### Third Embodiment

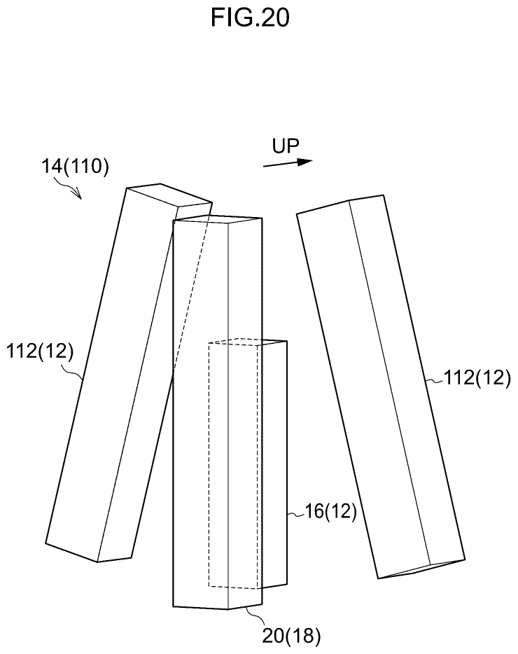

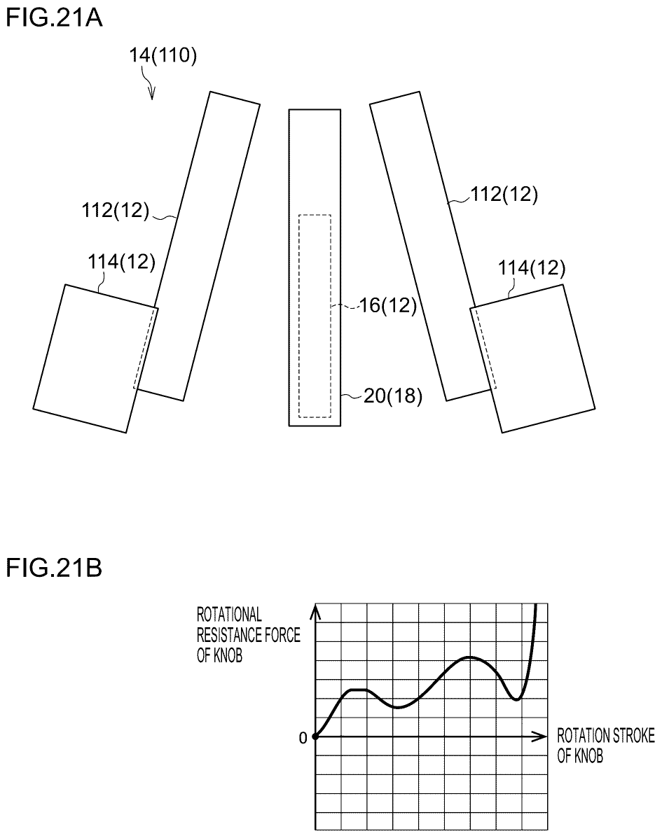

FIG. 20 is a perspective view illustrating a main part of a shifting device 110 according to a third embodiment of the invention, and FIG. 21A is a bottom view illustrating the main part of the shifting device 110.

The shifting device 110 according to the present embodiment has substantially the same configuration as that of the first embodiment, but is different in the following points.

The shifting device 110 according to the present embodiment is of a momentary type, and a knob 18 is rotated to change a shift position of the knob 18 between a plurality of shift positions (in the present embodiment, five shift positions of an “R” position, an “N” position, an “H” position (home position), an “N” position, and a “D” position).

As illustrated in FIGS. 20 and 21A, a predetermined number (one in the present embodiment) of operation magnets 20 are fixed to an enlarged diameter portion 18C of the knob 18 (rotary cylinder 18B) from above, and the operation magnet 20 has an axial direction as a rotational-diameter direction of the knob 18 and an upper end and a lower end as magnetic poles.

A predetermined number (one in the present embodiment) of fixed magnets 16 are fixed to an upper plate 12A of a plate 12 from below, and the fixed magnet 16 has an axial direction as the rotational-diameter direction of the knob 18 and an upper end and a lower end as magnetic poles. The lower end of the fixed magnet 16 and the upper end of the operation magnet 20 have opposite magnetic poles, and an attractive force by a magnetic force is applied between the lower end of the fixed magnet 16 and the upper end of the operation magnet 20.

A return magnet 112 having a rectangular columnar shape as a fourth magnet is fixed to the upper plate 12A from below on both sides of the fixed magnet 16 in the rotation circumferential direction of the knob 18, and the return magnet 112 has an axial direction as the rotational-diameter direction of the knob 18 and an upper end and a lower end as magnetic poles. The lower end of the return magnet 112 and the upper end of the operation magnet 20 have the same magnetic pole, and a repulsive force due to a magnetic force is applied between the lower end of the return magnet 112 and the upper end of the operation magnet 20. The return magnet 112 is larger than the fixed magnet 16, and the magnetic force of the return magnet 112 is larger than the magnetic force of the fixed magnet 16.

When the knob 18 is rotated, the upper end of the operation magnet 20 sequentially faces the lower end of the fixed magnet 16 and the lower end of the return magnet 112 of the plate 12 above (in the rotational-axis direction of the knob 18). When the knob 18 is disposed at the third shift position (“H” position), the upper end of the operation magnet 20 faces the lower end of the fixed magnet 16 above.

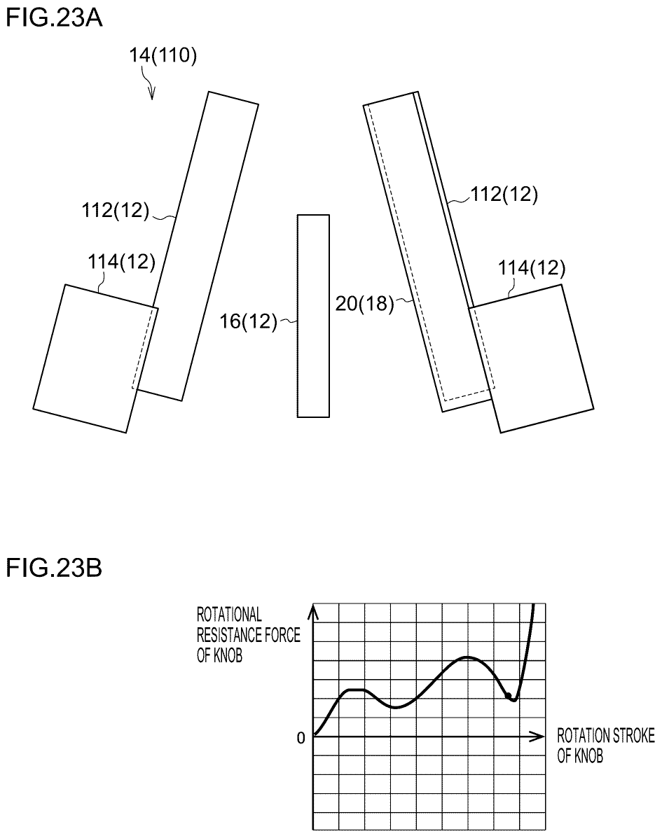

A pair of substantially rectangular plate-shaped regulation plates 114 as regulation portions are fixed in the plate 12, and the regulation plates 114 are inserted below an end portion of the return magnet 112 on a side opposite from the fixed magnet 16. The operation magnet 20 can abut on the regulation plate 114 (see FIG. 23A), and when the knob 18 is rotated to the first shift position (“R” position) and the fifth shift position (“D” position), the operation magnet 20 abuts on the regulation plate 114, and the rotation of the knob 18 (including the operation magnet 20) is regulated. Further, when the operation magnet 20 is brought into contact with the regulation plate 114, the center of the upper end of the operation magnet 20 (the center in the rotation circumferential direction of the knob 18) is immediately before facing the center of the lower end of the return magnet 112 (the center in the rotation circumferential direction of the knob 18) above.

A plurality of (five in the present embodiment) Hall ICs 26 are fixed to a top surface of the detection substrate 22, and when the knob 18 is disposed at each shift position, the lower end of the operation magnet 20 faces one Hall IC 26 different for each shift position below.

Next, functions of the present embodiment will be described.

In the shifting device 110 having the above configuration, when the rotational operation force is not applied to the knob 18, in the moderation mechanism 14, the upper end of the operation magnet 20 of the knob 18 and the lower end of the fixed magnet 16 of the plate 12 face each other in the vertical direction, and the attractive force in the vertical direction is applied between the upper end of the operation magnet 20 and the lower end of the fixed magnet 16, whereby the knob 18 is held at the third shift position (“H” position).

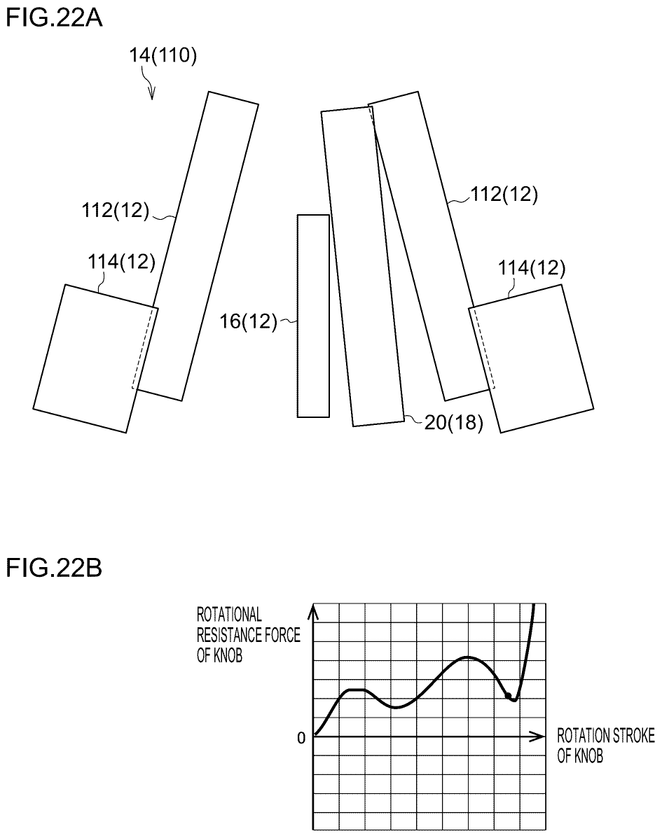

When the shift position of the knob 18 is changed from the third shift position to the second shift position or the fourth shift position (“N” position) (see FIGS. 22A and 22B), the operation magnet 20 is rotated from a position vertically facing the fixed magnet 16 to a position vertically facing the center between the fixed magnet 16 and the return magnet 112. Therefore, the upper end of the operation magnet 20 is rotated while being attracted to the lower end of the fixed magnet 16 and being repelled by the lower end of the return magnet 112, and a rotational resistance force is applied to the knob 18. In addition, a rotation circumferential component of the knob 18 of the attractive force between the upper end of the operation magnet 20 and the lower end of the fixed magnet 16 is maximized when an end of the upper end of the operation magnet 20 on the side opposite from the rotation direction of the knob 18 passes through an end of the lower end of the fixed magnet 16 on the side of the rotation direction of the knob 18. Therefore, when the shift position of the knob 18 is changed from the third shift position to the second shift position or the fourth shift position, the rotational resistance force applied to the knob 18 is gradually increased and then gradually decreased by the attractive force between the upper end of the operation magnet 20 and the lower end of the fixed magnet 16, and is gradually increased by the repulsive force between the upper end of the operation magnet 20 and the lower end of the return magnet 112. As a result, a magnetic force (biasing force) toward the third shift position is applied to the knob 18, and a moderation feeling is applied to an operation of changing the knob 18 from the third shift position to the second shift position or the fourth shift position.

When the shift position of the knob 18 is changed from the second shift position or the fourth shift position to the first shift position or the fifth shift position (the “R” position or the “D” position) (see FIGS. 23A and 23B), the operation magnet 20 is rotated from a position vertically facing the center between the fixed magnet 16 and the return magnet 112 to a position immediately before a position where the center of the upper end of the operation magnet 20 vertically faces the center of the lower end of the return magnet 112. Therefore, the upper end of the operation magnet 20 is rotated while being repelled by the lower end of the return magnet 112, and a rotational resistance force is applied to the knob 18. In addition, a rotation circumferential component of the knob 18 of the repulsive force between the upper end of the operation magnet 20 and the lower end of the return magnet 112 is maximized when an end of the upper end of the operation magnet 20 on the side of the rotation direction of the knob 18 passes through an end of the lower end of the return magnet 112 on the side opposite from the rotation direction of the knob 18. Therefore, when the shift position of the knob 18 is changed from the second shift position or the fourth shift position to the first shift position or the fifth shift position, the rotational resistance force applied to the knob 18 is gradually increased and then gradually decreased by the repulsive force between the upper end of the operation magnet 20 and the lower end of the return magnet 112. As a result, a magnetic force (biasing force) toward the third shift position is applied to the knob 18, and a moderation feeling is applied to an operation of changing the knob 18 from the second shift position or the fourth shift position to the first shift position or the fifth shift position.

As described above, when the knob 18 is disposed at a position other than the third shift position, a rotational resistance force is applied to the knob 18. Therefore, in a case where the applying of the rotational operation force to the knob 18 is released when the knob 18 is disposed at a position other than the third shift position, the knob 18 is rotated (returned) to the third shift position by the applied rotational resistance force.

Here, also in the present embodiment, functions and effects similar to those of the first embodiment can be obtained.

In particular, the operation magnet 20, and the fixed magnet 16 and the return magnet 112 face each other in the vertical direction (the rotational-axis direction of the knob 18 and the operation magnet 20). Therefore, the moderation mechanism 14 can be downsized in the rotational-diameter direction of the operation magnet 20, and the shifting device 110 can be downsized in the rotational-diameter direction of the knob 18.

Furthermore, when the knob 18 is rotated to the first shift position and the fifth shift position, immediately before the center of the upper end of the operation magnet 20 faces the center of the lower end of the return magnet 112 above, the operation magnet 20 abuts on the regulation plate 114 of the plate 12, and the rotation of the knob 18 is regulated. Therefore, it is possible to suppress a decrease in the rotational resistance force (the rotation circumferential component of the knob 18 of the repulsive force) due to the repulsive force between the upper end of the operation magnet 20 and the lower end of the return magnet 112 by the center of the upper end of the operation magnet 20 facing the center of the lower end of the return magnet 112 above, and it is possible to suppress a decrease in the rotational resistance force applied to the knob 18.

In a case where the knob 18 is provided with five shift positions, the moderation mechanism 14 includes the four magnets of the operation magnet 20, the fixed magnet 16, and the two return magnets 112. Therefore, the number of magnets can be reduced, and the cost can be reduced.

In the present embodiment, the return magnets 112 are arranged on both sides of the fixed magnet 16 in the rotation circumferential direction of the knob 18 in the plate 12. However, the return magnets 112 may be arranged on both sides of the operation magnet 20 in the rotation circumferential direction of the knob 18 in the knob 18. In this case, the repulsive force due to the magnetic force is applied between the lower end of the fixed magnet 16 and the upper end of the return magnet 112.

Further, the present embodiment is applied to the plate 12 and the knob 18 of the first embodiment. However, the present embodiment may be applied to the plate 12, the first gear 92A, and the second gear 92B of the second embodiment.

In the first embodiment (including the first modification to the sixth modification), the second embodiment (including the seventh modification), and the third embodiment, the fixed magnet 16 (including the first fixed magnet 16A and the second fixed magnet 16B) and the operation magnet 20 (including the first operation magnet 20A and the second operation magnet 20B) face each other in the rotational-axis direction of the operation magnet 20. However, the fixed magnet 16 (including the first fixed magnet 16A and the second fixed magnet 16B) and the operation magnet 20 (including the first operation magnet 20A and the second operation magnet 20B) may be separated in the rotational-diameter direction of the operation magnet 20 and need not face each other in the rotational-axis direction of the operation magnet 20.

Furthermore, in the first embodiment (including the first modification to the sixth modification), the second embodiment (including the seventh modification), and the third embodiment, the detection substrate 22 is arranged in the vertical direction. However, the detection substrate 22 may be arranged in parallel in the vertical direction, and for example, the plurality of Hall ICs 26 (including the first Hall ICs 26A and the second Hall ICs 26B) of the detection substrate 22 may be arranged at the vertical position of the operation magnet 20 (including the first operation magnet 20A and the second operation magnet 20B).

In the first embodiment (including the first modification to the sixth modification), the second embodiment (including the seventh modification), and the third embodiment, the knob 18 (shift body) is rotated about the center axis. However, the shift body may be pivoted (moved), and for example, a lever is integrated with the knob 18 to form the shift body, whereby the shift body (lever) may be pivoted with the knob 18 as the center axis to rotate the knob 18. Moreover, the shift body may be slid (moved), and for example, the shift body and the knob 18 may be connected by a rack-and-pinion mechanism to slide the shift body and rotate the knob 18.

The disclosure of Japanese Patent Application No. 2022-24235 filed on Feb. 18, 2022 is incorporated herein by reference in its entirety.

### REFERENCE SIGNS LIST

10 shifting device
16 fixed magnet (second magnet)
16A first fixed magnet (second magnet)
16B second fixed magnet (second magnet)
18 knob (shift body)
20 operation magnet (first magnet)
20A first operation magnet (first magnet)
20B second operation magnet (first magnet)
22 detection substrate (detection device)
26 Hall IC (detection unit)
26A first Hall IC (detection unit)
26B second Hall IC (detection unit)
30 shifting device
32 repulsive magnet (third magnet)
40 shifting device
50 shifting device
60 shifting device
70 shifting device
80 shifting device
90 shifting device
92A first gear (rotary body)
92B second gear (rotary body)
100 shifting device
110 shifting device
112 return magnet (fourth magnet)
114 regulation plate (regulation portion)

1. A shifting device comprising:
a shift body that is moved to change a shift position;
a first magnet that is rotated by moving the shift body; and
a second magnet that is disposed on a rotational-axis direction side of the first magnet, an attractive force being applied between the first magnet and the second magnet to apply a moving force toward the shift position to the shift body.

2. The shifting device according to claim 1, comprising:
a detection device that detects a position of the first magnet and detects the shift position of the shift body.

3. The shifting device according to claim 2, wherein
a plurality of detection units are provided at the detection device, and the shift position of the shift body is changed to change the detection unit that detects the position of the first magnet.

4. The shifting device according to claim 3, wherein
the shift position of the shift body is changed to change a combination of the detection units that detect the position of the first magnet.

5. The shifting device according to claim 1, comprising:
a rotary body that is provided with the first magnet and is rotated in conjunction with the shift body.

6. The shifting device according to claim 5, comprising:
a plurality of rotary bodies.

7. The shifting device according to claim 1, comprising:
a third magnet that is disposed between one of the first magnets or the second magnets, a repulsive force being applied between another of the first magnets or the second magnets and the third magnet.

8. The shifting device according to claim 7, wherein
one of the first magnet or the second magnet and the third magnet are formed of the same magnet.

9. The shifting device according to claim 1, comprising:
a fourth magnet, a repulsive force being applied between one of the first magnet or the second magnet and the fourth magnet; and
a regulation portion that regulates rotation of the first magnet before a center of one of the first magnet or the second magnet and a center of the fourth magnet face each other.

10. The shifting device according to claim 1, wherein
at least one of the first magnet or the second magnet is equally disposed in a rotation circumferential direction of the first magnet.
